(19) United States
(12) Patent Application Publication
(10) Pub. No.: US 2014/0036413 A1
(43) Pub. Date: Feb. 6, 2014

(54) ELECTROCHEMICAL CAPACITOR

(71) Applicant: Taiyo Yuden Co., Ltd., Tokyo (JP)

(72) Inventors: Naoto Hagiwara, Gunma (JP); Kyotaro Mano, Gunma (JP)

(73) Assignee: Taiyo Yuden Co., Ltd., Tokyo (JP)

(21) Appl. No.: 13/954,081

(22) Filed: Jul. 30, 2013

(30) Foreign Application Priority Data
Jul. 31, 2012 (JP) 2012-169082

(51) Int. Cl. H01G 9/08

(52) U.S. Cl. CPC H01G 9/08
USPC 361/508

(57) ABSTRACT

An electrochemical capacitor includes a casing, an electrolyte, a storage element, a wiring and an adhesive layer. The casing forms a liquid chamber. The electrolyte is housed in the liquid chamber. The storage element is a storage element in which a positive electrode sheet, a separator sheet and a negative electrode sheet are laminated, being housed in the liquid chamber. A capacitance formed between a positive electrode active material in the positive electrode sheet and the electrolyte is greater than a capacitance formed between a negative electrode active material in the negative electrode sheet and the electrolyte. The wiring is connected to the liquid chamber. The adhesive layer is made of a conductive adhesive made with a synthetic resin including conductive particles. The adhesive layer covers the wiring, causes the positive electrode sheet to adhere to the casing, and electrically connects the wiring with the positive electrode sheet.

### CROSS-REFERENCE TO RELATED APPLICATION

This application claims priority under 35 U.S.C. §119 to Japanese Patent Application No. JP 2012-169082 filed on Jul. 31, 2012, the entire content of which is hereby incorporated herein by reference in its entirety.

### FIELD

The present disclosure relates to an electrochemical capacitor including a chargeable/dischargeable storage element.

### BACKGROUND

Electrochemical capacitors each including a chargeable/dischargeable storage element have been widely used for a back-up power supply and the like. In general, such an electrochemical capacitor has a structure in which a storage element and an electrolyte are sealed in an insulating casing. A wiring is formed in the insulating casing. The wiring is in conduction with the sealed storage element.

Here, in such an electrochemical capacitor, it is necessary to protect a wiring from galvanic corrosion due to the charge/discharge of the storage element. For example, Japanese Patent Application Laid-open No. 2001-216952 describes “battery of nonaqueous electrolyte and capacitor with electrically double layers” in which a wiring is made of a metal having high corrosion resistance such as gold and silver. Further, Japanese Patent Application Laid-open No. 2006-303381 describes “electric double layer capacitor and battery” in which a configuration in which the wiring is coated by a protective layer made of a conductive adhesive is employed.

### SUMMARY

However, in the case where the wiring is made of a metal having high corrosion resistance, the types of metals which can be used as the wiring are limited. Further, in the case where the wiring is coated with a conductive adhesive, there is a fear that the conductive adhesive deteriorates with charging and discharging of the electrochemical capacitor, and as a result, conductivity inside the electrochemical capacitor decreases.

In view of the above-mentioned circumstances, it is desirable to provide an electrochemical capacitor capable of preventing decrease in conductivity due to charging and discharging of a storage element.

According to an embodiment of the present disclosure, there is provided an electrochemical capacitor including a casing, an electrolyte, a storage element, a wiring and an adhesive layer.

The casing forms a liquid chamber.

The electrolyte is housed in the liquid chamber.

The storage element is a storage element in which a positive electrode sheet, a separator sheet and a negative electrode sheet are laminated, being housed in the liquid chamber and configured so that a capacitance formed between a positive electrode active material included in the positive electrode sheet and the electrolyte is greater than a capacitance formed between a negative electrode active material included in the negative electrode sheet and the electrolyte.

The wiring is connected to the liquid chamber.

The adhesive layer is made of a conductive adhesive made with a synthetic resin including conductive particles, and is configured to coat the wiring, to cause the positive electrode sheet to adhere to the casing, and to electrically connect the wiring with the positive electrode sheet.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 is a perspective view of an electrochemical capacitor according to an embodiment of the present disclosure;

FIG. 2 is a cross-sectional view of the electrochemical capacitor;

FIG. 3 is a plan view of the electrochemical capacitor;

FIG. 4 is a graph showing the change in potential of the positive electrode and the negative electrode of the electrochemical capacitor;

FIG. 5 is a table showing the configuration of electrochemical capacitors according to Examples of the present disclosure and Comparative Examples;

FIG. 6 is a graph showing the measurement results of internal resistance of the electrochemical capacitors according to Examples of the present disclosure and Comparative Example; and

FIG. 7 is a graph showing the measurement results of internal resistance of the electrochemical capacitors according to Examples of the present disclosure and Comparative Example.

### DETAILED DESCRIPTION OF THE EMBODIMENTS

According to an embodiment of the present disclosure, there is provided an electrochemical capacitor including a casing, an electrolyte, a storage element, a wiring and an adhesive layer.

The casing forms a liquid chamber.

The electrolyte is housed in the liquid chamber.

The storage element is a storage element in which a positive electrode sheet, a separator sheet and a negative electrode sheet are laminated, being housed in the liquid chamber and configured so that a capacitance formed between a positive electrode active material included in the positive electrode sheet and the electrolyte is greater than a capacitance formed between a negative electrode active material included in the negative electrode sheet and the electrolyte.

The wiring is connected to the liquid chamber.

The adhesive layer is made of a conductive adhesive made with a synthetic resin including conductive particles, and is configured to cover the wiring, to cause the positive electrode sheet to adhere to the casing, and to electrically connect the wiring with the positive electrode sheet.

With this configuration, the capacitance formed between the positive electrode active material included in the positive electrode sheet and the electrolyte is greater than the capacitance formed between the negative electrode active material included in the negative electrode sheet and the electrolyte. Therefore, the rise in potential of the positive electrode with charging is suppressed. This enables to prevent deterioration of the adhesive layer that electrically connects the wiring to the positive electrode sheet as the adhesive layer covers and protects the wiring. Specifically, deterioration due to oxidation of the synthetic resin contained in the adhesive layer is prevented, and intercalation by an anion to the conductive particles contained in the adhesive layer is prevented. Thus, the adhesive layer is prevented from deterioration.

The positive electrode active material and the negative electrode active material may be made of the same material, the positive electrode active material and the negative electrode active material may have the same specific surface area, and an amount of the positive electrode active material contained in the positive electrode sheet may be greater than an amount of the negative electrode active material contained in the negative electrode sheet.

In the case where the active material is the same material, the capacitance formed between the active material and the electrolyte is determined by the amount and the specific surface area of the active material contained in the electrode sheet. Therefore, in the case where the positive electrode active material and the negative electrode active material have the same specific surface area with each other, the capacitance formed between the positive electrode active material and the electrolyte can be made greater than the capacitance formed between the negative electrode active material and the electrolyte by making the amount of the positive electrode active material greater than the amount of the negative electrode active material.

A density of the positive electrode active material contained in the positive electrode sheet and a density of the negative electrode active material contained in the negative electrode sheet may be the same with each other, and a volume of the positive electrode sheet may be greater than a volume of the negative electrode sheet.

In the case where the density of the positive electrode active material and the density of the negative electrode active material are the same with each other, the amount of the positive electrode active material can be made greater than the amount of the negative electrode active material by making the volume of the positive electrode sheet greater than the volume of the negative electrode sheet. In the case where the density of the positive electrode active material and the density of the negative electrode active material are the same with each other, the positive electrode sheet and the negative electrode sheet can be prepared using electrode sheets prepared by the same production method. In addition, the volumes of the positive electrode sheet and the negative electrode sheet can be defined by the respective thicknesses and sheet areas of electrode sheets.

The conductive particles may be graphite particles.

Graphite particles have high chemical stability, and are often used as conductive particles contained in the conductive adhesive. However, in an electrochemical capacitor, at high potential, intercalation (intrusion of the anion into the graphite intercalation) by an anion contained in the electrolyte to the graphite can occur. When graphite particles swell due to the intercalation, there is a fear that cracks may occur in the adhesive layer and may result in loss of functions of the conductive adhesive layer of conductivity and the function to protect the wiring. However, in the electrochemical capacitor according to the embodiment of the present disclosure, as the rise in potential of the positive electrode with charging is suppressed as described above, such intercalation by the anion to the graphite is prevented. Therefore, even in cases where graphite particles are employed as the conductive particles of the conductive adhesive, the adhesive layer can be prevented from deterioration due to the intercalation.

The synthetic resin may be a phenol resin.

For its characteristics such as a low swelling property with respect to the electrolyte, high thermal resistance and high chemical stability, a phenol resin is often used as a synthetic resin which makes up the conductive adhesive. However, as the phenol resin is prone to undergoing oxidative decomposition, in the case where it is employed as the conductive adhesive for adhesion of the positive electrode sheet of the electrochemical capacitor, there has been a problem that functions of the conductive adhesive layer of conductivity and the function to protect the wiring decreases due to oxidation occurring with the high potential of the positive electrode. However, in the electrochemical capacitor according to the embodiment of the present disclosure, since the rise in potential of the positive electrode with charging is suppressed as described above, deterioration of the phenol resin due to oxidation can be prevented. Therefore, the adhesive layer can be prevented from deterioration.

A thickness of the synthetic resin in the adhesive layer may be smaller than an average particle diameter of the conductive particles.

If conductive particles contained in the adhesive layer do not have continuity with the positive electrode active material, the potential of the conductive particles would rise. By making the thickness of the synthetic resin smaller than the average particle diameter of the conductive particles, the conductive particles and the positive electrode active material can be physically brought into contact with each other so as to ensure the electrical continuity. Thus, the rise in potential at the conductive particles can be suppressed.

The positive electrode active material and the negative electrode active material may be an activated carbon.

Because of its large specific surface area, an activated carbon is frequently used as an active material of an electrochemical capacitor. The positive electrode sheet and the negative electrode sheet can be prepared by cutting a sheet (electrode sheet) obtained by casting a mixture of the activated carbon, a conductive auxiliary agent and a binder. An amount of the active material contained in the electrode sheet can be controlled with composition of the mixture and with degree of rolling of the electrode sheet.

The electrolyte may include an anion having an ionic radius equal to or less than 3.5 angstrom.

Because of its size, an anion having an ionic radius equal to or less than 3.5 angstrom (such as tetrafluoroborate ion (BF₄⁻)) can be easily intercalated into the graphite. However, in the electrochemical capacitor according to the embodiment of the present disclosure, as the rise in potential of the positive electrode with charging is prevented as described above, the intercalation by the anion to the graphite would not occur. Accordingly, the present disclosure can be highly effective especially in electrochemical capacitors that use an electrolyte including an anion having an ionic radius equal to or less than 3.5 angstrom. The ionic radius can be calculated using Van der Waals volume of the ion.

An electrochemical capacitor according to an embodiment of the present disclosure will be described.

### [Configuration of Electrochemical Capacitor]

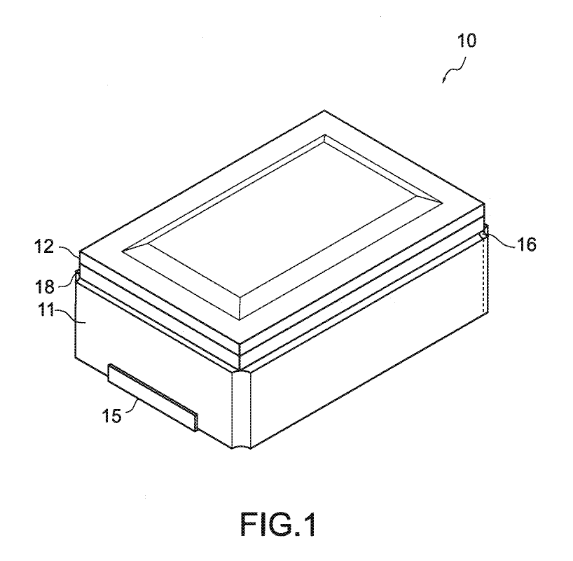

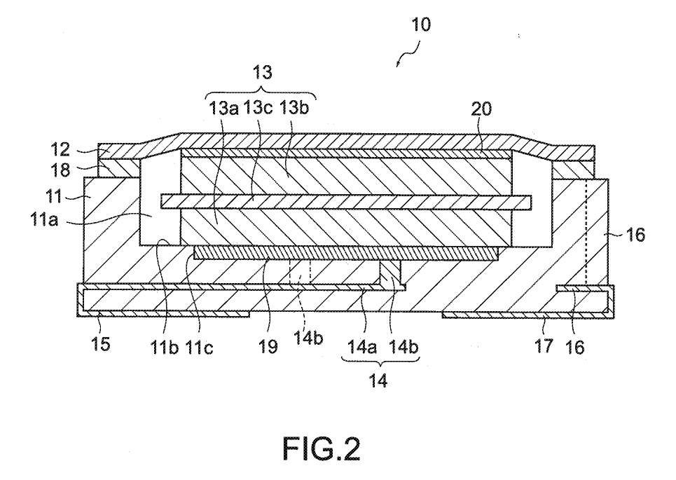

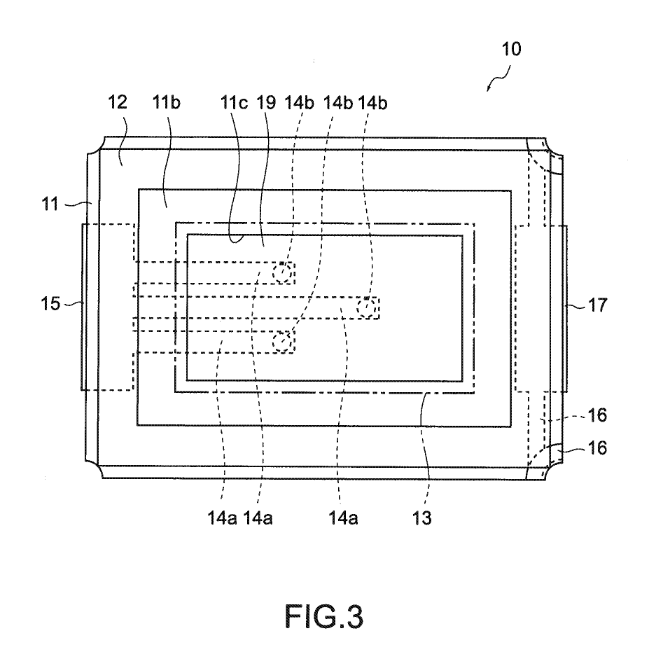

FIG. 1 is a perspective view of an electrochemical capacitor 10 according to this embodiment. FIG. 2 is a cross-sectional view of the electrochemical capacitor 10. FIG. 3 is a plan view of the electrochemical capacitor 10. As shown in those figures, the electrochemical capacitor 10 includes a casing 11, a lid 12, a storage element 13, a positive-electrode wiring 14, a positive-electrode terminal 15, a negative-electrode wiring 16, a negative-electrode terminal 17, a sealing ring 18, a positive-electrode adhesive layer 19 and a negative-electrode adhesive layer 20.

As shown in FIG. 2, the electrochemical capacitor 10 is configured by joining the casing 11 to the lid 12 via the sealing ring 18 and sealing the storage element 13 and the electrolyte in a liquid chamber 11a thus formed. Although will be described later in detail, the positive-electrode wiring 14 passes through an inside of the casing 11 and electrically connects a positive electrode of the storage element 13 to the positive-electrode terminal 15. The negative-electrode wiring 16 passes through the inside of the casing 11 and electrically connects a negative electrode of the storage element 13 to the negative-electrode terminal 17. The storage element 13 is fixed to the casing 11 by the positive-electrode adhesive layer 19, and is fixed to the lid 12 by the negative-electrode adhesive layer 20.

The casing 11 is made of an insulating material such as ceramics, and forms the liquid chamber 11a together with the lid 12. The casing 11 may be formed in a recess shape so as to form the liquid chamber 11a. For example, the casing 11 may be formed in a rectangular parallelepiped shape as shown in FIG. 1 or in another shape such as a cylindrical shape. A surface corresponding to the bottom surface of the liquid chamber 11a of the casing 11 is referred to as a bottom surface 11b. A recess 11c is formed at the center of the bottom surface 11b.

The lid 12 is joined to the casing 11 via the sealing ring 18 to seal the liquid chamber 11a. The lid 12 may be made of a conductive material such as various types of metals. For example, the lid 12 may be made of kovar (iron-nickel-cobalt alloy). Alternatively, the lid 12 may be made of a clad material having a matrix material such as kovar covered with a film made of a metal having high corrosion resistance such as nickel, platinum, silver, gold, and palladium in order to prevent galvanic corrosion.

The lid 12 is joined to the casing 11 via the sealing ring 18 to seal the liquid chamber 11a, which is sealed after placing the storage element 13 inside the liquid chamber 11a. For coupling of the lid 12 to the sealing ring 18, in addition to a direct joining method such as seam welding or laser welding, an indirect joining method using a conductive joining material may be utilized.

The storage element 13 is housed in the liquid chamber 11a. The storage element 13 stores electric charge (charging), or emits the electric charge (discharging). As shown in FIG. 2, the storage element 13 includes a positive electrode sheet 13a, a negative electrode sheet 13b, and a separator sheet 13c. The positive electrode sheet 13a and the negative electrode sheet 13b is sandwiching the separator sheet 13c therebetween. The storage element 13 may be placed on the bottom surface 11b such that the positive electrode sheet 13a is on a side of the bottom surface 11b. The storage element 13 will be described later in detail.

The electrolyte to be housed together with the storage element 13 in the liquid chamber 11a may be arbitrarily selected. The electrolyte may include an anion having an ionic radius equal to or less than 3.5 angstrom. Examples of such anions include BF₄⁻(tetrafluoroborate ion), PF₆⁻(hexafluorophosphate ion), (CF₃SO₂)₂N⁻ (TFSA ion) and the like. For example, the electrolyte may be a quaternary ammonium salt solution in which BF₄⁻ is contained. Specifically, it can be a 5-azoniaspiro[4.4]nonane-BF₄ solution or an ethylmethylimidazolium nonane-BF₄ solution.

The positive-electrode wiring 14 electrically connects (the positive electrode sheet 13a of) the storage element 13 to the positive-electrode terminal 15. Specifically, the positive-electrode wiring 14 includes band-like portions 14a and via-portions 14b. The band-like portions 14a pass through the inside of the casing 11 from the positive-electrode terminal 15 to directly below the recess 11c. The via-portions 14b are formed to extend from the band-like portions 14a toward the casing 11. A plurality of band-like portions 14a and a plurality of via-portions 14b may be provided.

The via-portions 14b are connected to the recess 11c. The via-portions 14b are held in contact with the positive-electrode adhesive layer 19 filled in the recess 11c and having conductivity. The via-portions 14b are in conduction with the positive electrode sheet 13a via the positive-electrode adhesive layer 19. The positive-electrode wiring 14 may be made of a conductive material such as various kinds of metals. Although will be described later in detail, the via-portions 14b are protected by the positive-electrode adhesive layer 19 from galvanic corrosion. Therefore, materials of the positive-electrode wiring 14 may be selected from a wide range of materials irrespective of corrosion resistance. For example, the positive-electrode wiring 14 may be made of tungsten. The via-portions 14b may be obtained by forming a nickel film and a gold film on tungsten.

The positive-electrode terminal 15 is connected to the positive electrode (positive electrode sheet 13a) of the storage element 13 by the positive-electrode wiring 14. The positive-electrode terminal 15 is used for connection to an outside, for example, a mounting substrate. The positive-electrode terminal 15 may be made of an arbitrary conductive material. As shown in FIG. 2, the positive-electrode terminal 15 may be formed from a side surface toward a lower surface of the casing 11.

The negative-electrode wiring 16 electrically connects the storage element 13 (the negative electrode sheet 13b of the storage element 13) and the negative-electrode terminal 17. Specifically, the negative-electrode wiring 16 may be formed along an outer periphery of the casing 11 from the negative-electrode terminal 17 and connected to the sealing ring 18. The negative-electrode wiring 16 is in conduction with the negative electrode sheet 13b via the sealing ring 18, the lid 12, and the negative-electrode adhesive layer 20 having conductivity. The negative-electrode wiring 16 may be made of an arbitrary conductive material.

The negative-electrode terminal 17 is connected to the negative electrode (negative electrode sheet 13b) of the storage element 13 by the negative-electrode wiring 16. The negative-electrode terminal 17 is used for connection to the outside, for example, the mounting substrate. The negative-electrode terminal 17 may be made of an arbitrary conductive material. As shown in FIG. 2, the negative-electrode terminal 17 may be formed from the side surface toward the lower surface of the casing 11.

The sealing ring 18 connects the casing 11 to the lid 12 to seal the liquid chamber 11a. The sealing ring 18 electrically connects the lid 12 to the negative-electrode wiring 16. The sealing ring 18 may be made of a conductive material such as Kovar (iron-nickel-cobalt alloy). Further, a corrosion-resistant film (such as nickel film and gold film) may be formed on a surface of the sealing ring 18. The sealing ring 18 may be joined to the casing 11 and the lid 12 via a brazing material (gold-copper alloy or the like).

The positive-electrode adhesive layer 19 covers the positive-electrode wiring 14 (via-portions 14b). The positive-electrode adhesive layer 19 causes the positive electrode sheet 13a to adhere to the casing 11. The positive-electrode adhesive layer 19 electrically connects the positive-electrode wiring 14 to the positive electrode sheet 13a. Thus, the positive-electrode wiring 14 is protected from the electrolyte with the positive-electrode adhesive layer 19. The positive-electrode adhesive layer 19 is obtained by curing the conductive adhesive filled in the recess 11c. The conductive adhesive may be a synthetic resin including conductive particles.

The conductive particles contained in the positive-electrode adhesive layer 19 may be graphite particles. Graphite particles have high conductivity and chemical stability and can be suitably used as the conductive particles contained in the conductive adhesive. However, graphite has the property of swelling by undergoing intercalation (intrusion of the anion into the graphite intercalation) of the anion in the electrolyte, for example, BF₄⁻, at high potential (for example, 4.65 V vs. Li/Li⁺). If the graphite particles swell due to the intercalation, there is a fear that the synthetic resin of the positive-electrode adhesive layer 19 may be cracked and lose the function to protect the positive-electrode wiring 14. Therefore, it is necessary to prevent this intercalation.

The synthetic resin contained in the positive-electrode adhesive layer 19 may be a phenol resin. A phenol resin is favorable in view of a low swelling property with respect to the electrolyte, high thermal resistance, high chemical stability, and the like. However, the phenol resin is prone to undergoing oxidative decomposition, and is necessary to be prevented from being oxidized.

As shown in FIG. 1, the positive-electrode adhesive layer 19 is formed in the recess 11c and covers the positive-electrode wiring 14 (the via-portions 14b) connected to the recess 11c. With this, the electrolyte housed in the liquid chamber 11a is prevented from being brought into contact with the positive-electrode wiring 14 to protect the positive-electrode wiring 14 from galvanic corrosion.

In addition, as the positive-electrode adhesive layer 19, one in which the thickness of the synthetic resin is smaller than the average particle diameter of the conductive particles is favorable. For example, in the case where the positive-electrode adhesive layer 19 is made of the conductive adhesive made with the phenol resin including the graphite particles, one in which the thickness of the phenol resin is smaller than the average particle diameter of the graphite particles is favorable.

If the conductive particles contained in the positive-electrode adhesive layer 19 do not have continuity with the positive electrode active material contained in the positive electrode sheet 13a (described later), the potential of the conductive particles would rise. By making the thickness of the synthetic resin smaller than the average particle diameter of the conductive particles, the conductive particles and the positive electrode active material can be physically brought into contact with each other so as to ensure the electrical continuity. Thus, the rise in potential at the conductive particles can be suppressed.

The negative-electrode adhesive layer 20 is formed between the storage element 13 and the lid 12. The negative-electrode adhesive layer 20 fixes the negative electrode sheet 13b to the lid 12 and electrically connects the negative electrode sheet 13b to the lid 12. The negative-electrode adhesive layer 20 is obtained by curing the conductive adhesive. As in the positive-electrode adhesive layer 19, the conductive adhesive may be a synthetic resin including conductive particles. Note that the negative-electrode adhesive layer 20 and the positive-electrode adhesive layer 19 may be made of the same kind of conductive adhesive or a different kind of conductive adhesive.

### [Storage Element]

As described above, the storage element 13 is configured with the positive electrode sheet 13a, the separator sheet 13c and the negative electrode sheet 13b being laminated.

The positive electrode sheet 13a is a sheet including an active material. The active material is a substance that allows electrolyte ions (for example, BF₄⁻) to be adsorbed to its surface to form an electric double-layer. The active material may be an activated carbon or PAS (Polyacenic Semiconductor: polyacenic organic semiconductors), for example. Hereinafter, the active material included in the positive electrode sheet 13a will be referred to as “positive electrode active material”. A capacitor is formed, by the electric double-layer, between the positive electrode active material and the electrolyte. Hence, a predetermined capacitance [F] is generated. The capacitance of the positive electrode sheet 13a is defined by the multiplied value of amount of the positive electrode active material [g], specific surface area of the positive electrode active material [m²/g] and specific capacity of the positive electrode active material [F/m²].

Specifically, the positive electrode sheet 13a may be one obtainable by rolling a mixture of active material particles (for example, an activated carbon), a conductive auxiliary agent (for example, Ketjen Black) and a binder (for example, PTFE (polytetrafluoroethylene)), forming it into a sheet shape and cutting it.

The separator sheet 13c is a sheet which provides electrical insulation between the electrodes. The separator sheet 13c may be a porous sheet made of a material such as glass fibers, cellulose fibers and plastic fibers.

The negative electrode sheet 13b, as well as the positive electrode sheet 13a, is a sheet including an active material. Hereinafter, the active material included in the negative electrode sheet 13b will be referred to as “negative electrode active material”. The negative electrode active material may be the same material as the materials of the positive electrode active material. In the case where the positive electrode active material is the activated carbon, the negative electrode active material may also be the activated carbon. It is also possible that the positive electrode active material and the negative electrode active material are different materials. In the negative electrode sheet 13b as well, the electrolyte ions are adsorbed to the surface of the negative electrode active material to form an electric double-layer. A capacitance of the negative electrode sheet 13b is also defined by the multiplied value of amount of the negative electrode active material [g], specific surface area of the negative electrode active material [m²/g] and specific capacity of the negative electrode active material [F/m²]. In the case where the material of the negative electrode active material is the same as the positive electrode active material, the specific capacity would also be the same.

The negative electrode sheet 13b, as well as the positive electrode sheet 13a, may be one obtainable by rolling a mixture of active material particles (for example, an activated carbon), a conductive auxiliary agent (for example, Ketjen Black) and a binder (for example, PTFE (polytetrafluoroethylene)), forming it into a sheet shape and cutting it.

In the storage element 13 of this embodiment, the capacitance of the positive electrode sheet 13a is greater than the capacitance of the negative electrode sheet 13b. Specifically, in the case where the positive electrode active material and the negative electrode active material are made of the same material, the amount of the positive electrode active material may be greater than the amount of the negative electrode active material.

In order to make the amount of the positive electrode active material greater than the amount of the negative electrode active material, the volume of the positive electrode sheet 13a may be greater than the negative electrode sheet 13b. Specifically, at least one of the thickness and the area (sheet area) of the positive electrode sheet 13a may be greater than the negative electrode sheet 13b.

In the case where the thickness of the positive electrode sheet 13a is made greater than the thickness of the negative electrode sheet 13b, the thickness of the positive electrode sheet 13a may desirably be equal to or less than 1.5 times the thickness of the negative electrode sheet 13b. This is because in cases where the thickness of the positive electrode sheet 13a is greater than 1.5 times the thickness of the negative electrode sheet 13b, a potential of the negative electrode becomes 1 V (vs. Li/Li⁺) or less, and insertion of a cation into the conductive particles (graphite) of the negative-electrode adhesive layer 20 occurs.

In addition, in the case where the positive electrode sheet 13a and the negative electrode sheet 13b have the same thickness and the amount of the positive electrode active material is made greater than that of the negative electrode active material by making the area of the positive electrode sheet 13a greater than the area of the negative electrode sheet 13b, the positive electrode sheet 13a and the negative electrode sheet 13b can be prepared with the use of the same sheet.

Further, also by making the density of the positive electrode active material greater than the density of the negative electrode active material, the amount of the positive electrode active material can be made greater than the amount of the negative electrode active material. Specifically, when the above-mentioned mixture of the active material, the conductive auxiliary agent and the binder is rolled to be made into the sheet shape, the positive electrode sheet 13a can be prepared from a sheet with the greater degree of rolling (such as the number of rolling), and the negative electrode sheet 13b can be prepared from a sheet with the smaller degree of rolling. Still further, by making the composition ratio of the positive electrode active material greater than the composition ratio of the negative electrode active material, the density of the positive electrode active material can be greater than the density of the negative electrode active material. Specifically, with respect to the above-mentioned mixture of the active material, the conductive auxiliary agent and the binder, such a mixture with the greater composition ratio of the active material may be made into the positive electrode sheet 13a, and such a mixture with the smaller composition ratio of the active material may be made into the negative electrode sheet 13b.

Furthermore, in order to make the capacitance of the positive electrode sheet 13a greater than the capacitance of the negative electrode sheet 13b, the surface area of the positive electrode active material may be made greater than the surface area of the negative electrode active material. Specifically, the particle diameter of the positive electrode active material may be smaller than the particle diameter of the negative electrode active material.

The way to make the capacitance of the positive electrode sheet 13a greater than the capacitance of the negative electrode sheet 13b may be in either manner of the above or the combination of the above. For example, it is also possible that the volume of the positive electrode sheet 13a is made greater than the volume of the negative electrode sheet 13b while the surface area of the positive electrode active material is smaller than that of the negative electrode active material.

[Effect]

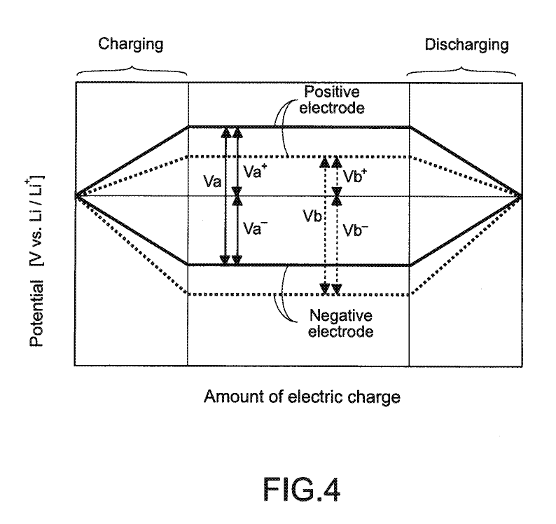

An effect of making the capacity of the positive electrode sheet 13a larger than the capacity of the negative electrode sheet 13b will be described. FIG. 4 is a graph showing the change in potential of the positive electrode and the negative electrode of the storage element.

The graph shown in solid line in FIG. 4, as a comparison, represents the potential of a storage element in which the capacitance of the positive electrode and the negative electrode are the same. When the storage element is charged, the potential of the positive electrode is increased and the potential of the negative electrode is decreased, to be polarized in a predetermined potential difference. Since the capacitance of the positive electrode sheet and the negative electrode sheet are the same, the polarization voltage Va⁺ of the positive electrode and the polarization voltage Va⁻ of the negative electrode are the same. Thus, the voltage Va between the positive electrode and the negative electrode becomes a predetermined value.

On the other hand, the graph shown in dashed line in FIG. 4 represents the potential of the storage element 13 in the present embodiment. In this embodiment, as described above, since the capacitance of the positive electrode sheet 13a is larger than the negative electrode sheet 13b, the polarization voltage Vb⁺ of the positive electrode becomes smaller than the polarization voltage Vb⁻ of the negative electrode. The voltage Vb between the positive electrode and the negative electrode is substantially the same as the voltage Va of the case where the capacitance of the positive electrode and the negative electrode are the same.

From a comparison of the case where the capacitance of the positive electrode and the negative electrode are the same (solid line) and the case of the present embodiment (dashed line), the potential of the positive electrode during charging can be lower in the present embodiment, while the voltage between the positive electrode and the negative electrode can be the same in both cases. Therefore, this embodiment enables lowering of the potential of the positive electrode without losing the performance of the electrochemical capacitor.

With the lowering of the potential of the positive electrode, the following effects can be obtained. That is, oxidation of the synthetic resin (especially phenol resin) contained in the conductive adhesive forming the positive-electrode adhesive layer 19 is reduced, and thus, deterioration of the synthetic resin due to oxidation can be prevented, and for example, decrease in conductivity of the positive-electrode adhesive layer 19 due to peeling of the synthetic resin, or the like, can be prevented.

Further, intercalation by the anion contained in the electrolyte to the conductive particles (especially graphite) contained in the adhesive layer is prevented, and cracking of the synthetic resin due to swelling of the conductive particles by the intercalation is prevented. For example, the intercalation of BF₄⁻ to graphite may occur at 4.65 V (vs. Li/Li⁺), but the potential of the positive electrode can be made lower than this potential.

As described above, in the electrochemical capacitor 10 according to the present embodiment, deterioration due to oxidation of the synthetic resin contained in the conductive adhesive which makes up the positive-electrode adhesive layer 19 is prevented, and intercalation of the anion to the conductive particles contained in the conductive adhesive is prevented. Therefore, the functions of the positive-electrode adhesive layer 19 of conductivity and the function to protect the positive-electrode wiring 14 would not be lost, and this enables to prevent decrease in conductivity of the electrochemical capacitor 10 due to charging and discharging of the storage element 13.

### EXAMPLES

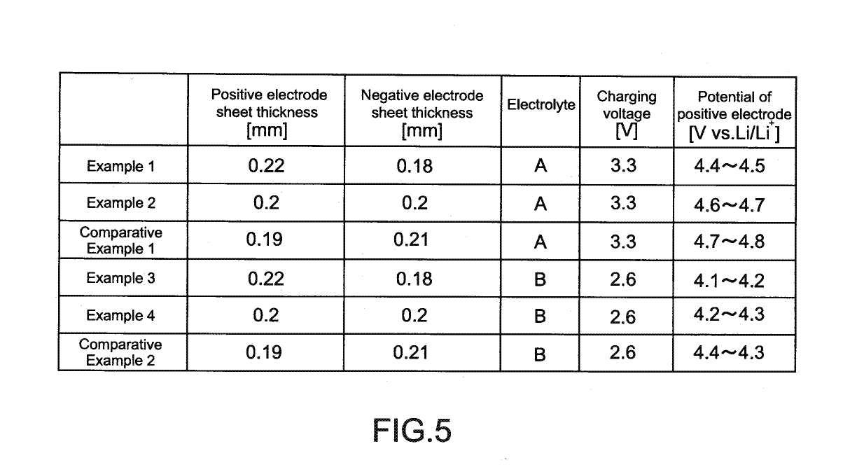

Examples and Comparative Examples according to the above-mentioned embodiment will now be described. FIG. 5 is a table showing the configuration of electrochemical capacitors according to Examples and Comparative Examples.

The electrochemical capacitors according to Examples and Comparative Examples were prepared in the following manner.

An activated carbon powder (active material) having a specific surface area of 1000 to 2000 m²/g, 15 wt % of Ketjen Black (conductive auxiliary agent) and 6 wt % of a PTFE powder (binder) were mixed together. By rolling the mixture, electrode sheets of various thicknesses were prepared. These electrode sheets were cut into 1-mm squares and were prepared into a positive electrode sheet and a negative electrode sheet. FIG. 5 shows the thicknesses of the positive electrode sheets and the negative electrode sheets of the respective electrochemical capacitors according to Examples and Comparative Examples. In such a way, with the conditions being the same except the thicknesses of the electrode sheets, the thickness of the electrode sheet has the same meaning as the amount of active material contained in each electrode sheet. Therefore, it has the same meaning as the capacitance of each electrode sheet.

To a recess of a casing connected with a wiring, a conductive adhesive (a phenol resin containing graphite particles) was coated with a thickness of about 10 μm. Components of the conductive adhesive were 10 to 20% carbon black (particle size 10 to 30 nm), 5 to 20% graphite (particle size 10 to 30 μm), 10 to 50% phenol resin and 10 to 75% butoxyethyl acetate. The viscosity of this conductive adhesive was 1 to 50 Pa·s. After this, the casing was heated to 200° C. by an oven to dry and cure the conductive adhesive, followed by causing the positive electrode sheet to adhere to the casing. It should be noted that the drying of the conductive adhesive may be performed after the adhesion of the positive electrode sheet.

The conductive adhesive was coated to a lid, and the negative electrode sheet was caused to adhere to the lid. The lid is a clad material having a total thickness of 0.1 mm with nickel adhered by rolling to the both sides of a kovar (iron-nickel-cobalt) alloy.

A separator sheet made of a glass fiber was placed on the positive electrode sheet adhered to the casing. An electrolyte was poured into the positive electrode sheet and the negative electrode sheet. The electrolyte was either of the following two types (see FIG. 5).
Electrolyte A
Salt: 5-azoniaspiro[4.4]nonane-BF₄
Solution: sulfolane+dimethyl sulfone
Salt concentration: 2 mol/L
Electrolyte B
Salt: ethylmethylimidazolium-BF₄
Solution: propylene carbonate
Salt concentration: 2 mol/L

A seal ring was placed on the casing, the lid was put on top of the seal ring, and they were sealed by laser welding. Each electrochemical capacitor was thus prepared. Rated voltage for the electrochemical capacitors according to Example 1 and Comparative Example 1 was 3.3 V, and rated voltage for the electrochemical capacitors according to Examples 3 and 4 and Comparative Example 2 was 2.6 V.

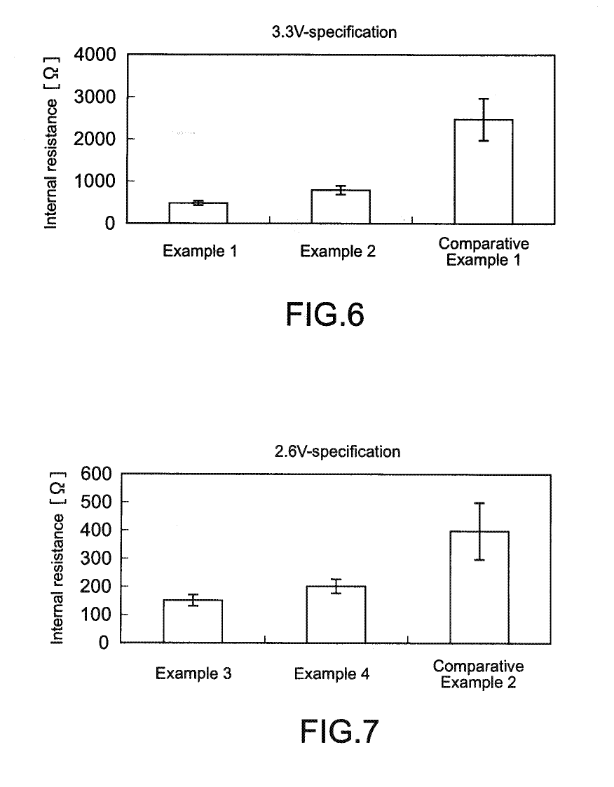

Each electrochemical capacitor was subjected to an accelerated reliability test. The accelerated reliability test was one performed by applying the rated voltage to each electrochemical capacitor, heating it to 70° C. and maintaining these conditions for 500 hours. After the test, internal resistance of each electrochemical capacitor was measured. FIGS. 6 and 7 are graphs showing the measurement results of internal resistance of the respective electrochemical capacitors.

As shown in FIGS. 6 and 7, the internal resistances found from the measurement of the electrochemical capacitors according to Examples were lower than those of the electrochemical capacitors according to Comparative Examples. This shows that positive-electrode adhesive layers of the electrochemical capacitors according to Examples had not deteriorated in the accelerated reliability test, and that the wirings had been well protected. On the other hand, the positive-electrode adhesive layers of the electrochemical capacitors according to Comparative Examples were found to have been deteriorated in the accelerated reliability test, and the conductivity of the positive-electrode adhesive layers and the wirings was found to have been decreased. Therefore, it can be said that the electrochemical capacitor according to the above-mentioned embodiment prevents decrease in conductivity due to oxidation.

Further, from a comparison between FIGS. 6 and 7, the effect of preventing an increase in the internal resistance was greater in the electrochemical capacitor whose rated voltage is 3.3 V than in the electrochemical capacitor whose rated voltage is 2.6 V. This shows that the effect by preventing the intercalation was greater in the electrochemical capacitor whose rated voltage is 3.3 V because the intercalation of the anion to the conductive particles (such as graphite particles) is more likely to occur when the potential of the positive electrode is high.

In addition, both the electrolytes A and B contain BF₄⁻ as the anion, and BF₄⁻ has a relatively small size (about 2.3 angstrom, diameter of 4.6 angstrom) as an anion in electrolytes that are usually used in electrochemical capacitors, which size is close to the interlayer distance of graphite (about 3.5 angstrom). This may easily cause intercalation into graphite. Similarly, (CF₃SO₂)₂N⁻, having an ionic radius of about 3.3 angstrom, may be intercalated into graphite, at about the same potential. According to the present disclosure, it can be said that the intercalation of such anions can be prevented, and thus can prevent deterioration of the adhesive layer and protect the positive-electrode wiring.

The present technology is not limited only to each of the above-mentioned embodiments and may be modified without departing from the gist of the present technology.

What is claimed is:

1. An electrochemical capacitor, comprising:
a casing which forms a liquid chamber;
an electrolyte housed in the liquid chamber;
a storage element in which a positive electrode sheet, a separator sheet and a negative electrode sheet are laminated,
being housed in the liquid chamber and
configured so that a capacitance formed between a positive electrode active material included in the positive electrode sheet and the electrolyte is greater than a capacitance formed between a negative electrode active material included in the negative electrode sheet and the electrolyte;
a wiring connected to the liquid chamber; and
an adhesive layer which
is made of a conductive adhesive made with a synthetic resin including conductive particles, and
is configured
to coat the wiring,
to cause the positive electrode sheet to adhere to the casing, and
to electrically connect the wiring with the positive electrode sheet.

2. The electrochemical capacitor according to claim 1, wherein
the positive electrode active material and the negative electrode active material are made of the same material,
the positive electrode active material and the negative electrode active material have the same specific surface area, and
an amount of the positive electrode active material contained in the positive electrode sheet is greater than an amount of the negative electrode active material contained in the negative electrode sheet.

3. The electrochemical capacitor according to claim 2, wherein
a density of the positive electrode active material contained in the positive electrode sheet and a density of the negative electrode active material contained in the negative electrode sheet are the same with each other, and
a volume of the positive electrode sheet is greater than a volume of the negative electrode sheet.

4. The electrochemical capacitor according to claim 1, wherein
the conductive particles are graphite particles.

5. The electrochemical capacitor according to claim 1, wherein
the synthetic resin is a phenol resin.

6. The electrochemical capacitor according to claim 1, wherein
a thickness of the synthetic resin in the adhesive layer is smaller than an average particle diameter of the conductive particles.

7. The electrochemical capacitor according to claim 1, wherein
the positive electrode active material and the negative electrode active material are an activated carbon.

8. The electrochemical capacitor according to claim 7, wherein
the electrolyte includes an anion having an ionic radius equal to or less than 3.5 angstrom.
